(19) United States
(12) Patent Application Publication
(10) Pub. No.: US 2005/0109693 A1
(43) Pub. Date: May 26, 2005

(54) Downspout filter

(76) Inventor: Douglas Allard, Santa Rosa, CA (US)

Correspondence Address: HOWREY SIMON ARNOLD & WHITE, LLP, c/o IP DOCKETING DEPARTMENT, 2941 FAIRVIEW PARK DRIVE, SUITE 200, FALLS CHURCH, VA, 22042-2924, US

(21) Appl. No.: 10/724,275

(22) Filed: Nov. 26, 2003

(51) Int. Cl. B01D 35/02

(52) U.S. Cl. 210/446; 52/16; 210/162; 210/323.1; 210/459

(57) ABSTRACT

An apparatus and method for reducing the amount of silt, sedimentation and pollution in storm water runoff as it passes across and through roofs, gutters, downspouts and other building components is disclosed. This is accomplished by placing a downspout filter comprising one or more water filtration or treatment elements directly into the flow of the fluid to be filtered or otherwise treated. Direct insertion of the downspout filter into a downspout at some point between the downspout inlet and outlet is preferable, such that all fluid passing through the downspout is forced to encounter this downspout filter. Such insertion may involve the cutting or separation of the downspout itself. This downspout filter also comprises one or more high flow bypasses to minimize the possibility of obstructions or backups, and, in addition to one or more filtration elements, may also comprises one or more additional water treatment elements, such as chitosan. Also provided is a secondary outlet and diversion valve, such that some or all passing fluid can be additionally treated to become potable or otherwise fit for personal or commercial purposes.

### TECHNICAL FIELD

The present invention relates generally to filtering or treating polluted or dirty fluid and more particularly to apparatuses and methods for use in reducing the amount of silt, sedimentation and pollution in storm water runoff as it passes across and through roofs, gutters, downspouts and other building components.

### BACKGROUND

Federal Environmental Protection Agency guidelines under the Clean Water Act require controlling pollution, silt and sediment found in storm water runoff and other sources of water. Federal and state agencies have issued mandates and developed guidelines regarding the prevention of point source (storm water caused) pollution that require action by local governments. These mandates affect water runoff from storms and also from other sources on slopes and construction sites. In addition, other laws and regulations exist that restrict the movement or disposal of significant amounts of water. Such laws and regulations have a significant impact on not only how storm water may be channeled and diverted, but also on, for example, the ways that contractors can dispose of excess or unwanted water from constructions sites.

Regulations also exist regarding the filtration or treatment of water that has passed across and through roofs, gutters, downspouts and other building components before such water can be introduced into storm water runoff systems and eventually into bays, rivers, estuaries and the like. Additional legislation in this regard adding more stringent requirements is anticipated. In addition, private entities, such as construction companies, commercial establishments and even homeowners may become affected by such additional regulations, such that private as well as public entities (i.e. any party with responsibility for a particular building) will be required to filter or otherwise treat water runoff that has passed across and through roofs, gutters, downspouts and other building components in some fashion.

Current methods of handling runoff from, e.g., roofs, gutters, walls, or various sources that collect fluids from buildings, is to channel the fluid flow into a downspout where the fluid flow is directed to an outlet at a another level, such as ground level. The fluid flow can then be diverted to an existing filtration system or released into other locations, such as a piping system. While this solution may be sufficient to meet existing regulations, it may be insufficient to meet anticipated requirements for the treatment of storm water runoff. Due to size and space limitations in certain areas, there may also be insufficient space to install adequate filtering mechanisms for treating water before it is released or diverted. Further, existing methods and systems for handling such fluids may place undue burdens on existing filtration systems. This may possibly lead to the failure of the existing filtration system, as its design of these systems may not have anticipated heavier loads. As regulations tighten and/or these and other various existing solutions require a higher standard of filtration, most or all current methods and systems for filtering or treating roof water runoff may prove to be inadequate. Accordingly, more effective devices and systems are desired for filtering or otherwise treating fluid runoff from roofs, gutters, downspouts and associated building components.

Chitosan is a well-known material that is derived from a naturally occurring substance called chitin, which is a polysaccharide found in the exoskeleton of shellfish such as shrimp, lobster, and or crabs. While chitosan is has recently gained popularity as a dietary supplement, its inherent ability to generate small electrical charges has also provided benefits in the processing of contaminated items, such as wastewater. In turbid or polluted water, the electrical charges given off by chitosan react with the small electrical charges in pollution, fine silt and sediment particles, such that many of these tiny bits of contamination and silt coagulate together into larger chunks. These larger coagulated chunks of particles can then be filtered more easily from the fluid and are also more prone to settle to the bottom of the fluid body via gravity. An appropriate application of chitosan can render a body of muddy water as fairly clear in a short period of time. While chitosan and chitin have been previously used to some extent in the treatment of wastewater, their use has yet to reach the field of storm water runoff or other dirty water coming under other concerns of the Clean Water Act, with its accompanying objective to filter or clarify such water. Thus, while advances have been made in the treatment of runoff, such as storm water runoff and other types of fluids containing sedimentation and debris, more effective devices and systems are desired for filtering or clarifying runoff or other polluted or dirty water using chitosan technologies.

### SUMMARY

It is an advantage of the present invention to provide an apparatus and method for reducing the amount of silt, sedimentation and pollution in storm water runoff as it passes across and through structures such as roofs, gutters, downspouts and other building components. According to one embodiment of the present invention, the provided apparatus and method involve the use of an innovative downspout filter placed directly in the flow of the fluid to be filtered. This can be accomplished by inserting a downspout filter into the downspout at some point between the downspout inlet and outlet, such that all fluid passing through the downspout is forced to encounter this downspout filter. In addition to preferably filtering or otherwise treating all runoff passing through it, this downspout filter also comprises one or more high flow bypasses to minimize the possibility of obstructions or backups, and also preferably comprises an additional water treatment element and diversion valve, such that some or all passing fluid can be additionally treated to become potable or otherwise usable for other personal or commercial purposes.

Other apparatuses, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures for the disclosed inventive downspout filter. These drawings in no way limit any changes in form and detail that may be made to the invention by one skilled in the art without departing from the spirit and scope of the invention.

FIG. 1 illustrates in top perspective view two typical prior art solutions for filtering or treating storm water runoff.

FIG. 2 illustrates in top perspective view an overview example of a building incorporating a downspout filter according to one embodiment of the present invention.

FIG. 3 illustrates in front perspective view an example of an assembled downspout filter according to one embodiment of the present invention.

FIG. 4 illustrates in front perspective view an example of an assembled downspout filter with filter cartridges according to one embodiment of the present invention.

FIG. 5 illustrates in front cross-sectional view an example of the downspout filter as depicted in FIG. 4, according to one embodiment of the present invention.

FIG. 6 illustrates in exploded side perspective view an example of the downspout filter as depicted in FIGS. 4 and 5, according to one embodiment of the present invention.

FIG. 7 illustrates in partial front cross-sectional view an example of a downspout filter employing an optional flow diverter system according to one embodiment of the present invention.

FIG. 8 illustrates in full frontal view an example of the downspout filter employing an optional flow diverter system as depicted in FIG. 7, according to one embodiment of the present invention.

### DETAILED DESCRIPTION

The following description illustrates an example of a system and method according to the present invention. This example is being provided solely to add context and aid in the understanding of the invention. Other applications are possible, such that this example should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention.

One advantage of the present invention is a marked improvement in the level of filtration and/or treatment given to and other fluid that passes across surfaces that collect or allow fluid flow. These surfaces could be flat, angled, or vertical such that they allow for fluid to flow or be collected and filtered by the present invention. As an example, the present invention improves the level of filtration and/or treatment given to storm water runoff that passes across and through roofs, walls, gutters, downspouts and other building components. This advantage is accomplished through the insertion of an innovative downspout filter directly into the flow of the fluid to be filtered, preferably into a downspout at some point between the inlet and outlet of the downspout.

Another advantage of the present invention is the implementation of filtering devices for treating water or pre-filtering water where space is limited. The downspout filter of the present invention can placed directly in the flow of storm water to allow for the removal of silt, sedimentation, and debris in small or narrow spaces.

Another advantage of the present invention is the ability to apply chitosan, chitin, and/or other water treatments to one or more elements of this downspout filter, thereby incorporating all of the benefits of these elements into the fluid treatment process.

Yet another advantage of the present invention is the valuable conversion of storm water runoff or other existing waters to potable drinking water or water that is at least otherwise useful for a variety of personal or commercial purposes. Accordingly, the present invention allows compliance with storm water runoff treatment regulations and may also provide for diverting otherwise wasted storm water runoff to domestic or commercially valuable uses. Thus, the present invention allows for conserving resources, while providing individuals and corporate entities with significant long-term savings in water, utility and other related costs.

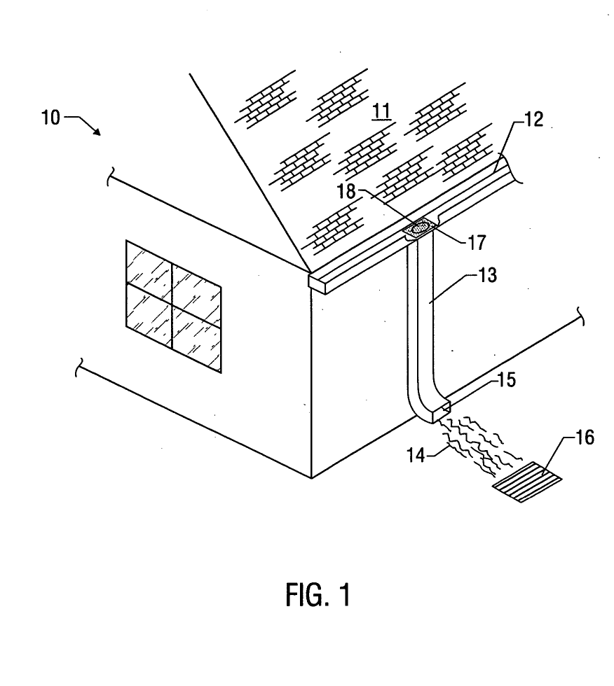

Referring now to FIG. 1, two conventional solutions to current regulations with respect to runoff from roofs, gutters, downspouts and the like are shown in top perspective view. A generic building 10 comprises a roof 11, one or more gutters 12 connected to the edges of the roof and one or more downspouts 13 extending downward from these gutters for channeling water runoff from the roof to some other lower level, such as ground. One solution to the foregoing problem is simply to divert the fluid flow 14 from the outlet 15 of downspout 13 to an already existing filtration system 16 at or below ground level, with such a system being in place to filter and/or treat water from other sources. While this solution may be sufficient to meet existing regulations regarding filtration or treatment of roof runoff, it can be inefficient and of unreliable quality, depending on the means for channeling runoff from downspout outlet 15 to existing filtration system 16. This solution may be inadequate to meet the more stringent regulations anticipated in the future. In addition, this solution places an additional and undue burden on the existing filtration system 16. In a worst case scenario, such an additional burden may lead to the failure of this existing filtration system, as it may not have been designed with this additional load in mind. At the very least, this burden will require an accelerated maintenance schedule for this existing system, likely causing inefficiencies in this system and likely shifting the burden of maintenance responsibilities from one party to another.

Another existing solution is to place a grating or other filtration element 17 into a roof gutter 12 and over the inlet 18 to a downspout 13 extending downward from said inlet. As in the foregoing example, this solution is inefficient and unreliable, depending on the quality and stability of filtration element 17. In addition, while this solution may serve to keep leaves and other large debris from entering the downspout, it is likely that the level of filtration provided will be insufficient to even meet existing regulations. In the event that filtration element 17 is adequate to provide the level of filtration or treatment required, it is likely that silt, sediment and other fine debris will accumulate in gutter 12 at a rapid rate, either clogging or otherwise hindering fluid flows, or, in extreme cases, causing damage to gutter 12 under the increased loads of such silt sediment and fine debris.

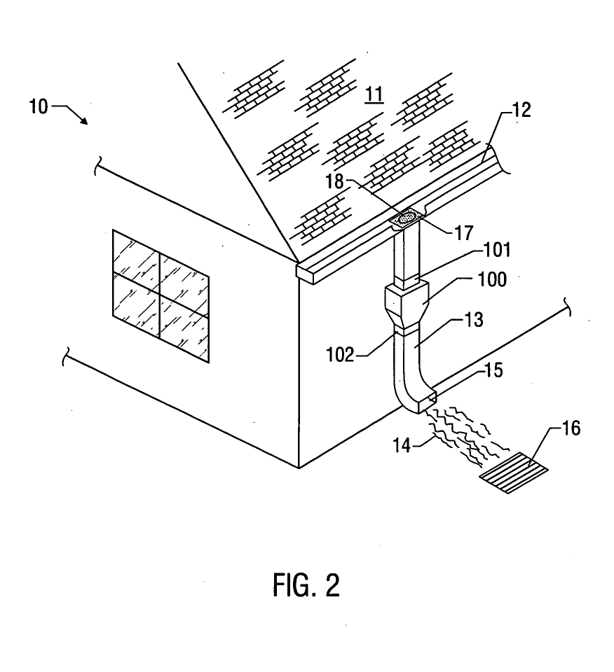

The present invention is directed generally toward a method or apparatus for filtering fluid that has passed or is passing across a surface of an elevated structure. Such elevated structure could include roofs, walls, gutters, downspouts and/or other like elements of a particular building or structure, where water could collect or pass. The fluid is collected from the surface of an elevated structure and filtered before entering ground-level drainages. Alternatively, the method or apparatus could collect water passing from pipes or structures at or below ground, and filtered before it is released. Referring now to FIG. 2, an overview example of a building incorporating a downspout filter according to one embodiment of the present invention is illustrated in top perspective view. A generic building 10, which may be substantially similar to the building as illustrated in FIG. 1, comprises a roof 11, one or more gutters 12 connected to the edges of the roof, and one or more downspouts 13 extending downward from these gutters for channeling water runoff from the roof to some other lower level, such as ground, each downspout having a downspout inlet 18 and a downspout outlet 15. The downspout may be vertically oriented, as shown here. Alternatively, the downspout may be horizontally oriented (not shown) such that water passes through the downspout in a horizontal direction. According to the present invention, a downspout filter 100 is generally coupled to said downspout, and is preferably coupled at a location that is between downspout inlet 18 and downspout outlet 15. This downspout filter also has one or more fluid treatment elements, such as filtration cartridges, the particulars of which are provided in greater detail below.

In a preferred embodiment, downspout filter 100 comprises a first inlet 101 and a first outlet 102, both of which are preferably adapted to couple with a downspout 13 in one or more downspout locations. First inlet 101 preferably couples to downspout 13 at a location downstream of downspout inlet 18, while first outlet 102 preferably couples to the downspout at a location upstream of downspout outlet 15. Both first inlet 101 and first outlet 102 may generally comprise substantially cylindrical fixtures of some nominal length that are made from sheet metal, PVC piping, plastic tubing, ceramic, or other suitable material, although all other shapes and configurations suitable for coupling this downspout filter with a downspout are also contemplated. In a particularly preferred embodiment, this downspout filter 100 is installed by cutting or otherwise severing downspout 13 at one or more vertical locations along the downspout. The first inlet 101 of the downspout filter can then be attached to the bottom of the upper portion of the severed downspout, while the first outlet 102 of the downspout filter can be attached to the top of the lower portion of the severed downspout.

Coupling or attachment means for attaching the inlet and outlet of the downspout filter into the downspout may vary depending upon the materials used to form said inlet and outlet. In one particular embodiment, it is specifically contemplated that the inlet and outlet of the downspout filter be formed from sheet metal sized such that the severed portions of downspout are able to slidably mate into the inlet and outlet of the downspout filter like a sleeve. Permanent or semi-permanent attachment can then be made through a number of means, such as by welding or clamping, or through the use of screws, bolts, pins, rivets and the like. One or more gaskets, caulkings or other sealing devices (not shown) may optionally be adapted to mate with each downspout to downspout filter connection as desired to prevent or reduce leakage. Although not necessary, it is preferable that a section of the downspout be removed during the installation process, as the downspout filter tends to require some amount of vertical space, such that one simple cut into the downspout before installation may result in a significant displacement of the downspout outlet. Accordingly, two or more cuts in the downspout may be desired, such that a section of downspout corresponding to the height of the downspout filter can be removed.

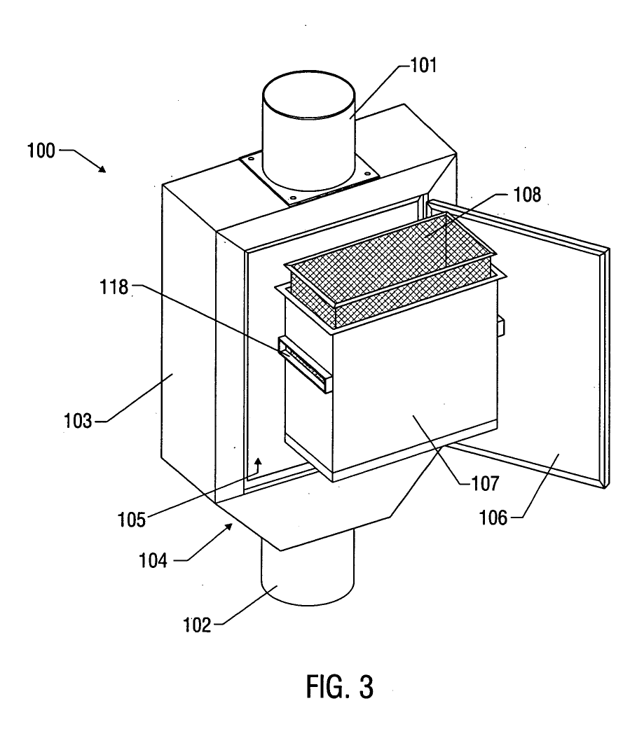

Turning now to FIG. 3, an example of an assembled downspout filter according to one embodiment of the present invention is illustrated in front perspective view. For ease of illustration, only downspout filter 100 and associated components are depicted, as other external elements such as a building, gutter and downspout have been omitted. Downspout filter 100 preferably comprises a first inlet 101 and a first outlet 102, some details of which have been described above. In a preferred embodiment, first inlet 101 and first outlet 102 are separate pieces that may be coupled or otherwise attached to the rest of downspout filter 100, such as by welding or clamping, or through the use of screws, bolts, pins, rivets and the like. It is also contemplated that this first inlet and first outlet be integrally formed with the rest of the downspout filter, although this is not necessary. Because the first inlet and first outlet are preferably separate pieces that are attached to the rest of the downspout filter though, these separate pieces may come in a variety of standardized shapes and sizes corresponding to a variety of standard downspout shapes and sizes, such that the remainder of the downspout filter may remain substantially universal for a variety of downspouts. In this manner, this first inlet and first outlet may also be referred to as adaptors or couplers capable of coupling any particular downspout filter to a variety of different downspouts.

Beyond first inlet 101 and first outlet 102, the rest of downspout filter 100 is preferably contained within an outer housing 103, which is preferably formed from sheet metal or other like components, but may also be cast, formed via plastic injection molding, or formed with any other appropriate material and corresponding formation process. Outer housing 103 can come in a variety of shapes and sizes, although it is preferable to be in a box or rectangular shape for ease of fabrication and use, with an optional taper 104 in a downward direction, as illustrated. This taper 104 may serve not only to indicate which direction is generally upward when handling, installing or otherwise viewing downspout filter 100, but may also aid in directing passing fluid toward and through first outlet 102.

In a particularly preferred embodiment, one or more access openings 105 are formed in one or more locations in outer housing 103, and such access openings may be used to adjust, repair, or otherwise provide regular maintenance on downspout filter 100 and one or more of its internal components. For example, one or more filter medium cartridges, as described in greater detail below, may require cleaning, replacement or other such maintenance on a steady periodic basis. Said one or more access openings 105 then provide a ready means for achieving such functions without the need for removal and/or substantial disassembly of the entire downspout filter. This access opening, or openings 105, may comprise, for example, a door or panel 106, preferably hinged, fabrication and coupling of which to a box-like outer housing 103 will be generally understood by those skilled in the art. Such a door or panel may or may not come with a fastening mechanism (not illustrated), which fastening mechanism may or may not come with a lock or other security feature, depending upon user preference. Such an access opening is only illustrative of one way to provide repair, adjustment or servicing, however, as one or more internal components of the downspout filter that may require repair, adjustment or servicing can alternatively be located and attached to the downspout filter in such a manner that they may be readily accessed individually, without the need for such a general access opening.

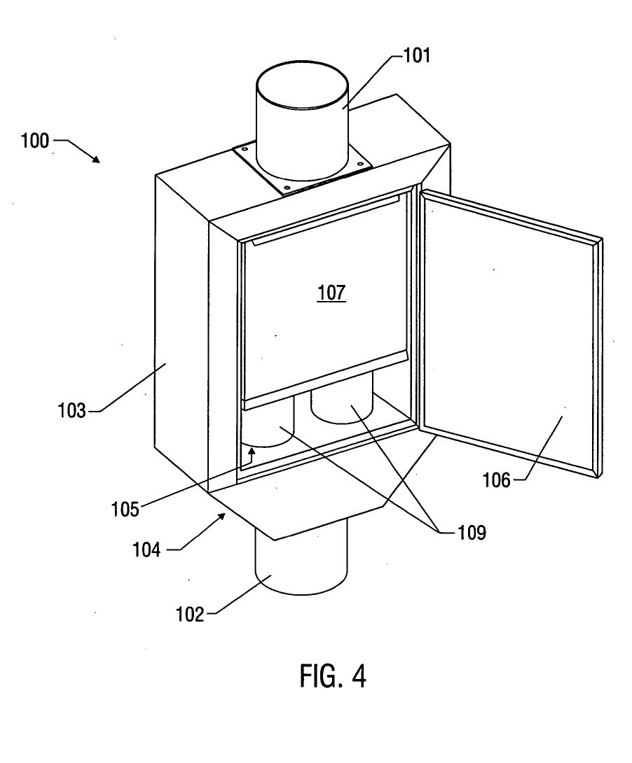

Referring again to FIG. 3, several internal components of exemplary downspout filter 100 can be seen in this front perspective view with hinged door or panel 106 in an open position, such that a portion of the structure inside outer housing 103 can be seen. A filter housing 107, which is preferably substantially impermeable, is adapted to house a filter basket or other filtration medium 108 (located completely inside filter housing 107 in FIGS. 3 and 4) and is removably stationed at a particular location within outer housing 103. Filter housing 107 containing filter basket 108 or other filtration medium is preferably located and attached within the downspout filter such that at least a portion of fluid passing through first inlet 101 will subsequently pass through this filter housing and the filtration medium contained therein. In a particularly preferred embodiment, filter housing 107 is situated such that substantially all fluid passing through first inlet 101 is potentially directed through this filter housing, although exceptions may occur in the event of a bypass or other irregular condition, as described in greater detail below. In this manner, a primary feature of the present invention, that being the ability to filter or otherwise treat substantially all fluid passing therethough during normal operating conditions, is realized. Additional features and variations are described below.

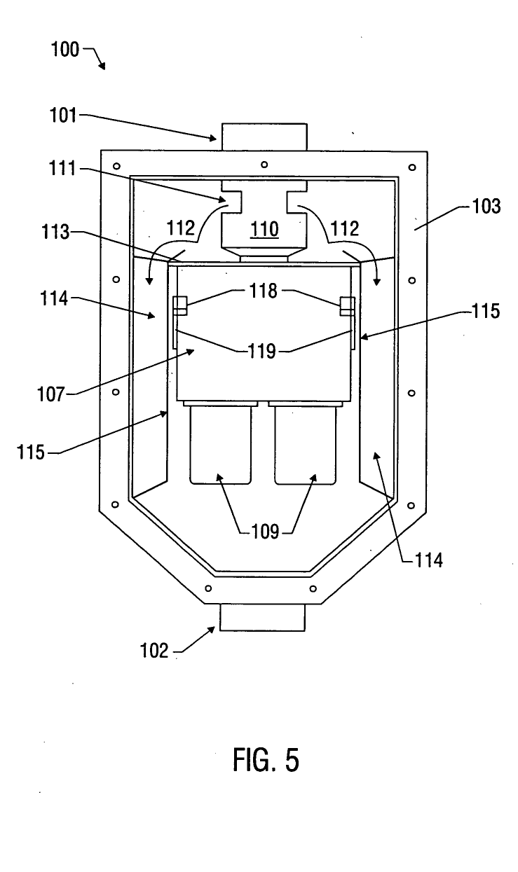

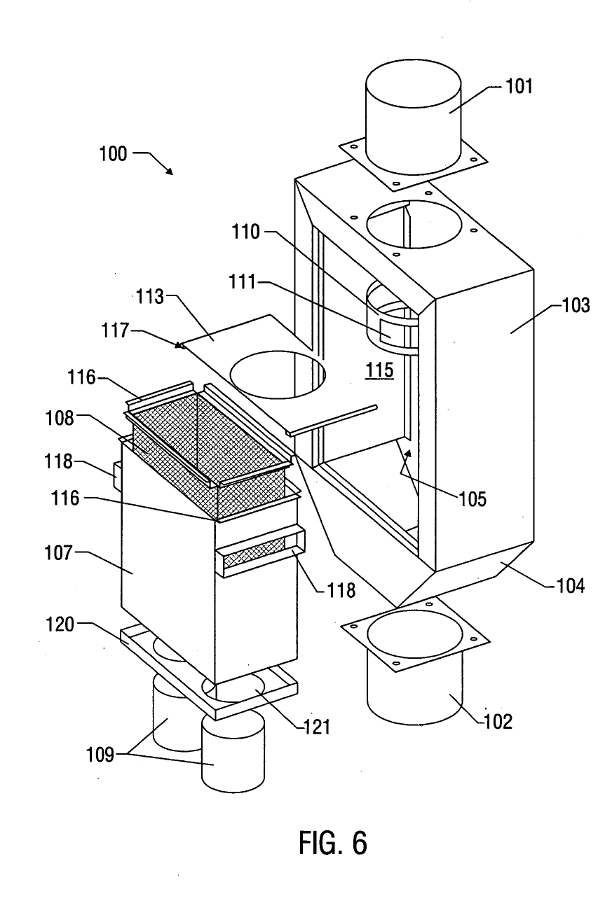

Another feature of the present invention is the ability to filter or treat fluid passing therethrough via a plurality of different filtration or treatment apparatuses or methods. As illustrated in FIG. 4, a further embodiment of the present invention incorporates filter cartridges in into the downspout filter. All downspout elements illustrated in FIG. 4 may also be seen in the front cross-sectional view provided in FIG. 5 and the exploded side perspective view provided in FIG. 6, further details of which are provided below. One or more filter medium cartridges 109 may be removably and suspendably coupled to the bottom of filter housing 107, such that fluid that has passed through this filter housing and the filter medium contained therein will then pass through one or more of these filter medium cartridges. Filter medium cartridges 109 may contain one or more filtration elements or materials as desired, and it is particularly preferable for these cartridges to contain perlite or any other common siliceous adsorbent material, such materials being recognized primarily for their ability to adsorb and separate oils, hydrocarbons and other various chemical pollutants from fluid runoff. Filter medium cartridges 109 are preferably cylindrical in nature, and are preferably comprised of one or more permeable outer surfaces, such that fluid passing into the cartridges may be treated by the perlite or other material contained therein, and then pass through one or more of those outer surfaces that are permeable.

In this manner, filter medium or basket 108 contained within filter housing 107 can be used primarily to filter out silt, sedimentation and other fine debris, while filter medium cartridges 109 can then be used to separate oils, hydrocarbons and other contaminants from the fluid that has passed through the filter housing and medium contained therein. After fluid, and preferably storm water runoff or the like, has passed though both filter basket 108 and filter medium cartridges 109, substantially all passing fluid may then encounter one or more downspout filter elements, as described in greater detail below, before passing on to a downspout filter outlet, such as first outlet 102, and ultimately back into the downspout or to some other final destination, as desired.

Referring now to FIG. 5, several additional features can be seen in the front cross-sectional view provided of the exemplary downspout filter illustrated in FIG. 4. As fluid enters downspout filter 100 via first inlet 101, it preferably encounters and passes through inlet pipe 110, wherefrom fluid then passes into filter housing 107 containing one or more filtration mediums. Inlet pipe 110 is a portion of inlet that is preferably substantially inside outer housing 103, although such a relationship is not absolutely necessary. Inlet pipe 110 may be integrally formed with the portion of first inlet 101 residing outside of outer housing 103 or, alternatively, may be an entirely separate element that is attached or otherwise coupled to either first inlet 101, the inside of outer housing 103, or both, via any suitable coupling means, such as by welding or clamping, or through the use of screws, bolts, pins, rivets and the like.

In a particularly preferred embodiment, inlet pipe 110 comprises one or more bypass openings 111, which provide a means for fluid to bypass the filtration elements below should the system experience heavy fluid flow, one or more blocked filtration components, or some other kind of failure. Bypass openings 111 preferably comprise slots where sections of material have been cut or otherwise removed from the walls of inlet pipe 110, such that fluid backing up through the entire system may pass through these bypass openings and down through an alternative bypass route 1 12 to a downspout filter outlet, such as first outlet 102. Although fluid or runoff passing through first inlet 101 and inlet pipe 1 10 will generally tend to continue downward regardless of the presence of bypass openings or slots 111 in the inlet pipe, it is preferable that slots 111 be cut or fabricated in such a way so as to provide a “catch” at the bottom of these slots, such as by slightly bowing the pipe material at the bottom of each slot outward or ensuring that the diameter of the inlet pipe is slightly larger at the bottom of the slots in comparison with the top. Alternatively, a relatively small splash guard, catch collar or other similar device (not illustrated) may be placed around inlet pipe 110 at the bottom of bypass openings or slots 111, such that splashed drops or other small amounts of fluid are generally redirected back into the bypass openings and inlet pipe during periods not designed for a bypass condition.

In a preferred embodiment of the present invention, the sum of the cross sectional areas of all bypass openings 111 should be equal to or greater than the cross-sectional area of the downspout to which the downspout filter is to be attached, such that the downspout filter is substantially less likely to be the cause of any stoppage or backup in the drainage system, which backup could result in the destruction of a system element, flooding of the gutters or other undesirable effects. Similarly, the sum of all cross-sectional areas for bypass routes is also preferably equal to or greater than the cross-sectional area of the downspout to which the downspout filter is to be attached, for the same reason. It is also preferable that bypass openings 111 be made in a symmetrical pattern, such as four symmetrical slots, in order to maintain the structural integrity and load supportability of inlet pipe 110 as best as possible.

As can be seen from FIGS. 5 and 6, one particular bypass route 1 12 preferably involves the passing of bypassed fluid through one or more bypass openings 111 onto a filter housing cover plate 113, such that this bypassed fluid does not enter or re-enter the filter housing 107. Instead, bypassed fluid preferably runs to and over one or more edges of filter housing cover plate 113 and preferably down one or more alternative fluid routes 114 within the downspout filter that are particularly designed for bypass flows. In a preferred embodiment, one or more internal walls 115 are located within and attached to outer housing 103 in such a way so as to allow bypassed fluid to fall between these internal walls and the walls of the outer housing. As in the foregoing examples, such an attachment of internal walls to the outer housing may be accomplished in a variety of ways, many of which will add an additional component of stability to the outer housing and downspout filter in general. Such means or ways may be accomplished, for example, by welding, clamping, gluing or simply casting these components together as one unit, or through the use of screws, bolts, pins, rivets and the like, although other suitable attaching means and methods are also contemplated.

In a particularly preferred embodiment, two or more such internal walls 1 15 are formed, each one in parallel with the side walls of outer housing 103, with each internal wall located between a side wall of outer housing 103 and a side wall of filter housing 107. In this embodiment, filter housing cover plate 113 substantially extends to the front and back walls of outer housing 103, and beyond at least the upper edge of one internal wall 115 to each side of the filter housing. Accordingly, substantially all fluid that completely passes through bypass openings 111 is channeled to and through one or more alternative fluid routes 114. Fluid passing through these alternative fluid routes may be directed to a common pool of fluid in order to be discharged via first outlet 102, such common pool of fluid including fluid that has been filtered or otherwise treated by some or all internal elements of the downspout filter as designed. Alternatively, additional structure may be added to channel bypassed fluid and/or partially or completely filtered and treated fluid to one or more alternative outlets for discharge from the downspout filter, as described below.

Again referring to FIG. 5, it can be seen that inlet pipe 1 10 contains a tapered or otherwise adapted component at its end for substantially delivering all passing fluid into the filter housing 107. This tapered or otherwise adapted end component may be separate from inlet pipe 110, although an integrated formation is preferred. In addition, while inlet pipe may be attached to filter housing 107, it is particularly preferable that no such attachment or, alternatively, a readily removable attachment be implemented, such that filter housing 107 can be readily removed from the entire downspout filter for maintenance purposes. Accordingly, a simple gasket or other similar device (not illustrated) around a central opening of the filter housing cover plate may be used to assist in delivering substantially all passing fluid from inlet pipe 110 through filter housing cover plate 113 and into filter housing 107 without the need for a firm connection between the inlet pipe and filter housing.

As illustrated in FIGS. 5 and 6, filter housing 107 and filter medium or basket 108 preferably have one or more flanges 116 around their upper lips, such that these components can be readily inserted and removed into the downspout filter, in order to facilitate the repair, maintenance, replacement and/or adjustment of these components. Flanges 116 are preferably formed and adapted such that each of these elements may be readily supported by one or more upper edges of one or more internal walls 1 15, in a matter that facilitates the slidable insertion and removable of these components from the outer housing 103. Although it is preferable that one or more upper edges of these internal walls be formed into a small flange or other horizontally oriented element, such a fabrication is not absolutely necessary. In one embodiment, filter housing cover plate 113 comprises curled edges 1 17 at one or more sides, such curled edges 117 being adapted to slidably accept and hold one or more flanges 116 of filter housing 107, filter basket 108, or both, such that these components can be assembled or disassembled as one unit, and inserted or removed into the downspout filter as one unit, generally atop one or more upper edges of one or more internal walls 115.

In a particularly preferred embodiment, the width, length and depth of filter basket 108 are nominally shorter than the width, length and depth of filter housing 107, such that adequate spacing exists between the walls and floor of the filter basket and the walls and floor of the filter housing. Accordingly, fluid passing through the filter basket may readily flow to the bottom of the filter housing and into one or more filter medium cartridges 109 attached thereto. In order to effect a proper spacing between the filter basket and filter housing, it is preferable that the flanges 1 16 of both the filter basket and filter housing be of appropriate dimensions, such that proper spacing will automatically occur when all flanges are inserted into curled edges 1 17 or any other serviceable common receiving means. Alternatively, appropriate spacing between the filter basket and filter housing walls may be had with manual adjustments during a standard installation or maintenance procedure.

Again referring to FIG. 5, a pair of filter medium cartridges 109 containing perlite or other similar adsorbent material are removably and suspendably attached to the bottom of filter housing 107. Such a removable attachment can be accomplished in a number of ways, such as, for example, by a threaded or twist-lock connection with both the openings in the bottom of filter housing 107 and the upper edges of each filter medium cartridge 109 being adapted for such a mating as would be readily understood by one skilled in the art. Other methods and means for providing such an attachment are also contemplated, with any such method or means providing firm attachment as well as some way for these filter medium cartridges to be removed for maintenance, refill or replacement. Preferably, the outer walls and/or floor of these filter medium cartridges are comprised of a suitable permeable or semi-permeable material, such that fluid passing through the perlite or other treatment material contained within these cartridges can then readily pass through the walls and/or floor of the cartridges, whereby such fluid can then preferably pass onward inside the downspout filter or out from the system entirely via first outlet 102.

In addition to other features such as flanges and holes and couplings for filter medium cartridges, a preferred embodiment of filter housing 107 also comprises one or more side openings 118 in one or more walls of the filter housing. These side openings 118 provide a separate bypass and alternative fluid route 119 that is distinct from the bypass openings 111 and alternative fluid or bypass 112 route discussed in detail above. In practice, this separate bypass will function as a primary filtered bypass, as backed up fluid will tend to pass through these side openings 1 18 before it will pass through the bypass openings 111 above them. In addition, fluid passing through side openings 118 will normally have been filtered by filter medium or basket 108 before arriving at these openings, such that use of side openings 118 as a primary bypass will involve the passage of fluid that has actually been filtered to some degree. Accordingly, the bypass openings 111 and alternative fluid or bypass route 112 detailed above actually becomes a secondary bypass, which should only become operable when the primary fluid route through all filtration elements and the primary bypass route both become backed up or otherwise fail. Such arrangement and functionality are desirable for a number of reasons; including the fact that fluid or runoff should not pass through the downspout filter without at least some level of treatment or filtering, except for extreme flow or other failure conditions.

Turning now to FIG. 6, the exemplary downspout filter depicted in FIGS. 4 and 5 according to one embodiment of the present invention is illustrated in exploded side perspective view. Accordingly, several relationships and features not visible or readily apparent from FIGS. 4 and 5 may be more readily ascertained from this exploded view. For example, filter housing may comprise a separable floor element 120 that can be attached to the remainder of the filter housing via any suitable means or method, such as by welding, clamping or gluing, or through the use of screws, bolts, pins, rivets and the like, although other suitable attaching means and methods are also contemplated. Just as in the case of an integrated floor, bottom holes 121 in this separable floor element are provided for the ready removable attachment of one or more filter medium cartridges 109. Additionally, first outlet 102 may be separately formed and attached to outer housing 103, similarly to first inlet 101.

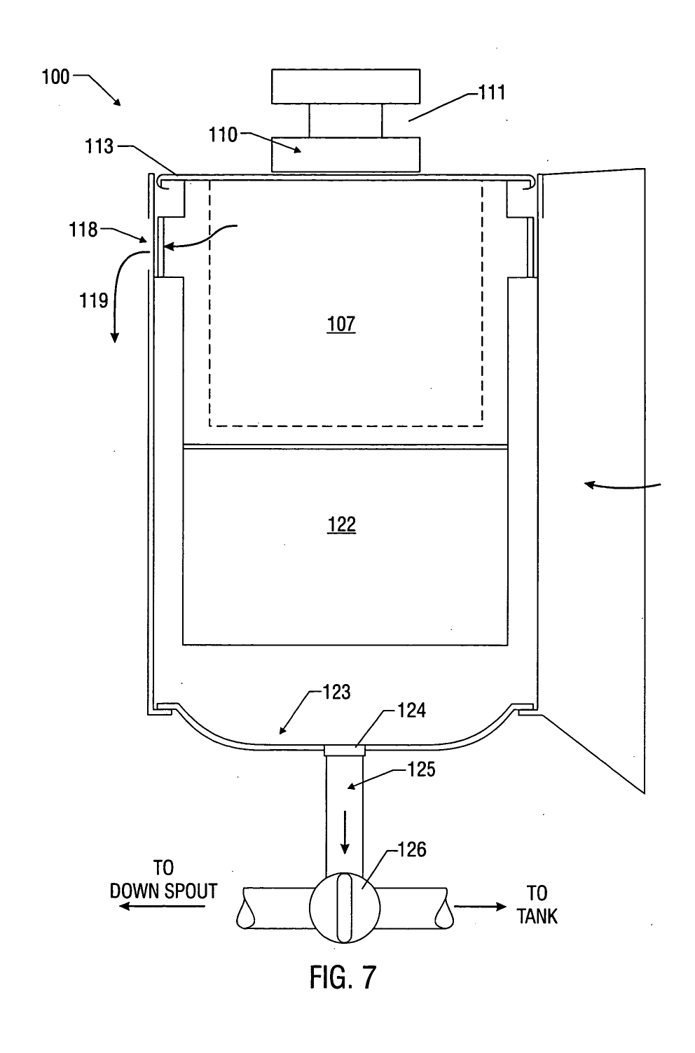

Referring now to FIG. 7, an example of a downspout filter employing an optional flow diverter system according to one embodiment of the present invention is illustrated in partial front cross-sectional view. While this embodiment may be substantially similar to the foregoing embodiments, one or more elements may be omitted or replaced with other more preferable elements. For example, while filter housing 107 containing filter basket 108 may be retained, an alternative treatment means or method 122 for providing a secondary treatment of passing fluid can be provided. Such alternative means can be in addition to or a replacement for the filtration medium cartridges discussed in detail above. Such alternative treatment means may comprise, for example one or more applications of chitosan or chitin in powder, gel, solution or other form, wherein such form or forms and application of same would be readily understood by one skilled in the art. Such an addition of chitosan as a fluid treatment means could be located, for example, within a sock or other similar form in inlet pipe 1 10, as a powder, gel or solution applied to the filter basket or medium 108, or as an addition to alternative treatment means 122.

In one embodiment, the alternative treatment means 122 for treating passing fluid or runoff may comprise a container having potability tablets or another similarly suitable solid, powder or solution for converting at least a portion of passing runoff into potable water. Because standards for potable water are relatively high in comparison to other standards, however, it is likely that a high amount of supervision and maintenance will be required for such an optional potable water collection and return system. Accordingly, it is also contemplated that alternative treatment means 122 for treating passing fluid or runoff be equipped with another suitable water treatment or treatments having standards that are less stringent than those required for potable water. In at least some instances, it is possible that the filtration medium cartridges containing perlite of the foregoing example will be sufficient for this purpose. In this manner, at least a portion of passing fluid may also be treated to the extent necessary to be classified as “reclaimed” or otherwise usable for other industrial, commercial or personal purposes having standards lower than those of drinking water. As in the case of the filtration medium cartridges, it is preferable that at least some portion of the walls and/or floor of alternative treatment means 122 be permeable or semi-permeable, such that treated water may then pass therethrough and onward into the remainder of the downspout filter.

As seen in FIG. 7, a collector pan 123 is preferably located below alternative treatment means 122 in this particular embodiment, such that fluid passing through alternative treatment means is separated, collected and diverted away from any fluid that passes through the downspout filter via any other route. As discussed above, alternative treatment means 122 can possibly comprise one or more filtration medium cartridges of the foregoing example, such that the foregoing embodiments could similarly be adapted to comprise a collector pan 123 and the remainder of the optional flow diverted system disclosed herein. This collector plan preferably substantially extends sufficiently in all directions within outer housing 103 and inner walls 115 such that substantially all fluid that passes through alternative treatment means 122 is collected in the collector pan. In addition, collector pan 123 preferably has one or more flanges, such that it may be slidably inserted and removed from one or more flanges or shelves attached to one or more walls or other components of outer housing 103 and/or inner walls 115. Alternatively, this collector pan may be permanently attached to one or more structural components, such as the outer housing or inner walls, via welding, clamping, gluing or any other suitable permanent attaching means or technique.

Attached to the bottom of collector pan 123 is a secondary outlet 124, which secondary outlet feeds secondary outlet tubing or hose 125. This secondary outlet hose 125 directs passing fluid to a diverter valve 126, which valve is preferably capable of directing or diverting passing fluid toward one or more of a plurality of distinct destinations. For example, diverter valve 126 may have two outlets, one of which directs passing fluid back into the original downspout, the other of which directs passing fluid to a storage container or tank (not illustrated). In this manner, a user has the option of saving filtered and treated water, or returning this water back to the downspout with any other water that may be returned to the downspout. Such an option may be desirable, for instance, when the selection for a storage container is intended to be for potable water, but water readings or other indications show that alternative treatment means 122 needs to be restocked with potability tablets or solution, serviced for some other reason, or is simply failing, and the user does not wish to pass substandard water through to the storage container.

Hence, it is readily apparent that any fluid passing through the first inlet 101 of downspout filter 100 may potentially be filtered through filter basket or other filtration medium 108, through one or more filtration medium cartridges and/or one or more alternative treatment means 122, into and past collector pan 123 and diverter valve 126, and into a collection tank for potable water. In the event of sufficiently low fluid flows, it is contemplated that a large portion of up to substantially all passing fluid will traverse such an optimal path. In the event of increased fluid flows or system elements needing maintenance, however, backups may occur such that one or more bypasses as described above may be utilized. It should also be readily apparent that fluid passing through any such bypass should not be and is not passed into collector pan 123 such that it can be directed toward diverter valve 126. Instead, any such fluid passing through a bypass is channeled via an alternative fluid path to a location beneath collector pan 123 so that such fluid can presumably be passed through first outlet 102 of the downspout filter.

Although not illustrated, it is also contemplated that a secondary collector pan or like device may also be utilized to further separate fluids depending upon which bypass said fluids pass through, as fluid passing through the initial bypass will have experienced at least some level of filtration or treatment. Implementation of such a secondary collector pan will be rather straightforward and similar to the implementation of collector pan 123, as will be readily understood by one skilled in the art. In the event of such use, like components for an outlet tubing or hose and diverter valve will also be preferable, such that the partially treated fluid may be separated and stored in some meaningful manner.

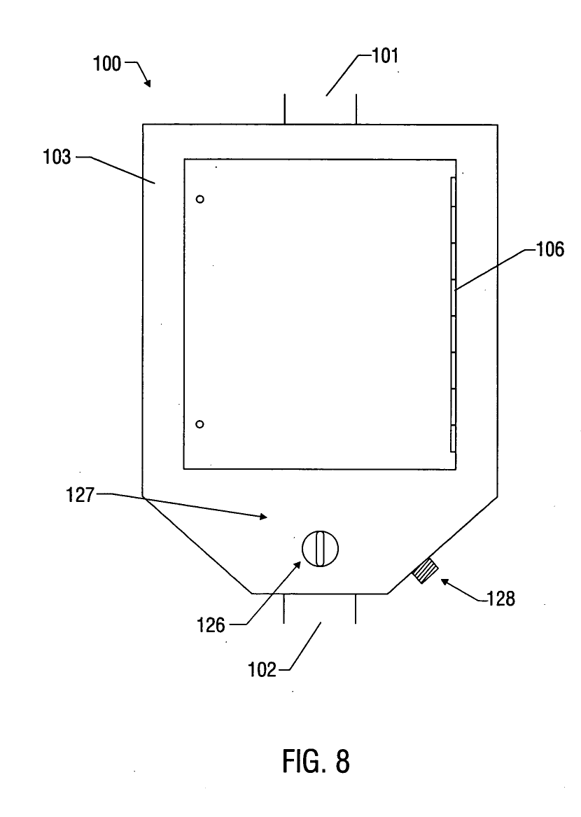

Turning now to FIG. 8, the example of a downspout filter employing an optional flow diverter system as depicted in FIG. 6 is illustrated in full frontal view. Hinged door or panel 106 is in the operable or closed position, and diverter valve 126 is centrally located near the bottom of the downspout filter. Engraved or raised lettering 127 may be used to provide directions and/or designations for various settings of the diverter valve, although a label or other suitable marking means may also be used for this purpose. In addition, a hose bib or nipple 128 is preferably provided in outer housing 103 at a location corresponding to the output of diverter valve 126 that is intended to direct fluid to a storage container or tank, with the general first outlet 102 providing the destination for the alternative path extending from the diverter valve.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

1. An apparatus, comprising:
a first inlet, said first inlet adapted to be coupled with a downspout, said downspout having a downspout inlet and a downspout outlet;
a first outlet, said first outlet disposed at a location on said apparatus subsequent to said first inlet; and
one or more fluid treatment elements adapted to treat fluid passing through said apparatus, at least one of said one or more fluid treatment elements disposed at a location between said first inlet and said first outlet.

2. The apparatus of claim 1, wherein at least one of said one or more fluid treatment elements comprises a filter element.

3. The apparatus of claim 2, wherein said filter element comprises a filter cartridge.

4. The apparatus of claim 1, wherein said one or more fluid treatment elements comprises a plurality of filter cartridges.

5. The apparatus of claim 1, wherein said first inlet is coupled with said downspout at a location on said downspout subsequent to said downspout inlet.

6. The apparatus of claim 5, wherein said first outlet is coupled with said downspout at a location on said downspout prior to said downspout outlet.

7. The apparatus of claim 6, wherein said apparatus is entirely inserted into said downspout at a location between said downspout inlet and said downspout outlet.

8. The apparatus of claim 7, wherein such insertion involves the cutting of said downspout at the location of insertion.

9. The apparatus of claim 7, wherein such insertion involves the removal of a section of downspout at the location of insertion.

10. The apparatus of claim 1, further comprising:
an outer housing, said outer housing adapted to contain at least one of said one or more fluid treatment elements.

11. The apparatus of claim 1, further comprising:
a primary bypass, said primary bypass adapted to provide a first alternative route for fluid to pass through said apparatus.

12. The apparatus of claim 11, wherein said primary bypass passes fluid through said apparatus via said first alternative route during periods when at least one of said one or more filtration elements are unable to handle the volume of fluid passing through said apparatus.

13. The apparatus of claim 11, further comprising:
a secondary bypass distinct from said primary bypass, said secondary bypass adapted to provide a second alternative route for fluid to pass through said apparatus.

14. The apparatus of claim 1, further comprising:
a second outlet, said second outlet adapted to direct fluid away from said downspout.

15. The apparatus of claim 14, wherein at least a portion of fluid passing through said second outlet is water that has been treated to be of sufficient quality for personal or commercial use.

16. The apparatus of claim 14, wherein at least a portion of fluid passing through said second outlet is potable water.

17. The apparatus of claim 1, further comprising:
one or more applications of chitosan disposed at one or more locations about said apparatus.

18. The apparatus of claim 1, further comprising:
a valve, said valve adapted to direct fluid toward said downspout outlet, toward some other destination, or both.

19. A downspout filter, comprising:
a first inlet, said first inlet adapted to be coupled with a downspout, said downspout having a downspout inlet and a downspout outlet;
a first outlet, said first outlet disposed at a location on said downspout filter subsequent to said first inlet; and
one or more fluid treatment elements adapted to treat fluid passing through said downspout filter.

20. The downspout filter of claim 19, wherein said one or more fluid treatment elements comprises a filter element.

21. The downspout filter of claim 20, wherein said filter element comprises a filter cartridge.

22. The downspout filter of claim 19, wherein said one or more fluid treatment elements comprises a plurality of filter cartridges.

23. The downspout filter of claim 19, wherein said first inlet is coupled with said downspout at a location on said downspout subsequent to said downspout inlet, and wherein said first outlet is coupled with said downspout at a location on said downspout prior to said-downspout outlet.

24. The downspout filter of claim 19, further comprising:
a housing, said housing adapted to contain at least one of said one or more fluid treatment elements;
a first bypass, said first bypass adapted to provide an alternative route for fluid to pass through said downspout filter;
a second outlet, said second outlet adapted to direct fluid away from said downspout; and
a valve, said valve adapted to direct fluid toward said downspout outlet, toward said second outlet, or both.

25. The downspout filter of claim 22, wherein at least a portion of fluid passing through said second outlet is water of sufficient quality for personal or commercial use.

26. The downspout filter of claim 23, wherein at least a portion of water passing through said second outlet is potable water.

27. The downspout filter of claim 19, further comprising:
one or more applications of chitosan disposed at one or more locations about said downspout filter.

28. The downspout filter of claim 19, further comprising:
a secondary bypass distinct from said primary bypass, said secondary bypass adapted to provide a second alternative route for fluid to pass through said downspout filter.

29. An apparatus, comprising:
a means for receiving fluid from a downspout, said downspout having a downspout inlet and a downspout outlet;
a means for passing said fluid out of said apparatus; and
a means for treating, said fluid as it passes through said apparatus, said means for treating said fluid being disposed at a location between said downspout inlet and said downspout outlet.

30. The apparatus of claim 29, wherein said means for passing passes said fluid back into said downspout.

31. The apparatus of claim 29, wherein said fluid treatment means comprises a filter element.

32. The apparatus of claim 31, wherein said filter element comprises a filter cartridge.

33. The apparatus of claim 29, further comprising:
a primary means for bypassing said fluid treating means, said primary bypassing means adapted to provide a first alternative route for fluid to pass through said apparatus.

34. The apparatus of claim 33, wherein said primary fluid bypassing means passes fluid through said apparatus via said first alternative route during periods when said fluid treatment means is unable to handle the volume of fluid passing through said apparatus.

35. The apparatus of claim 33, further comprising:
a secondary means for bypassing said fluid treatment means, said secondary bypassing means adapted to provide a second alternative route for fluid to pass through said apparatus.

36. The apparatus of claim 29, wherein at least a portion of fluid passing though said downspout outlet is water that has been treated to be sufficient quality for personal or commercial use.

37. The apparatus of claim 29, wherein at least a portion of fluid passing out of said passing means is potable water.

38. The apparatus of claim 29, further comprising:
a means for applying chitosan disposed at one or more locations about said apparatus.

39. The apparatus of claim 29, further comprising:
a diverting means, said diverting means adapted to direct fluid toward said downspout outlet, toward some other destination, or both.

40. A method of treating water runoff, comprising:
diverting storm water from one or more surfaces of an elevated structure to one or more water collection points;
passing said water from at least one of said one or more water collection points into a water filtration inlet;
filtering at least a portion of said water; and
passing said filtered water through a water filtration outlet.

41. A method for treating fluid, comprising:
selecting a downspout, said downspout having a downspout inlet and a downspout outlet;
inserting a downspout filter into said downspout, said downspout filter having a first inlet adapted to be coupled with said downspout, a first outlet disposed at a location subsequent to said first inlet, and one or more fluid treatment elements adapted to treat fluid passing through said downspout filter; and
permitting fluid to pass through said downspout.

42. The method of claim 41, further comprising the steps of:
directing at least a portion of said fluid from said downspout into said downspout filter; and
passing at least a portion of said fluid through said downspout filter.

43. The method of claim 42, further comprising the step of:
directing at least a portion of said fluid from said downspout filter back into said downspout after said fluid has passed through said downspout filter.

44. The method of claim 42, further comprising the step of:
directing at least a portion of said fluid from said downspout filter toward a second outlet of said downspout filter after said fluid has passed through said downspout filter.
